(19) United States
(12) Patent Application Publication
(10) Pub. No.: US 2026/0056743 A1
(43) Pub. Date: Feb. 26, 2026

(54) INSTRUCTION EXECUTION METHOD AND APPARATUS, COMPUTER DEVICE, STORAGE MEDIUM, AND COMPUTER PROGRAM PRODUCT

(71) Applicant: Glenfly Tech Co., Ltd., Shanghai (CN)

(72) Inventors: Renyu BIAN, Shanghai (CN); Huaisheng ZHANG, Shanghai (CN); Yuqin YU, Shanghai (CN); Yaohui ZENG, Shanghai (CN)

(21) Appl. No.: 19/264,270

(22) Filed: Jul. 9, 2025

(30) Foreign Application Priority Data
Aug. 22, 2024 (CN) 202411163866.4

(51) Int. Cl. G06F 9/30; G06F 9/38

(52) U.S. Cl. CPC G06F 9/30145; G06F 9/3802

(57) ABSTRACT

The present disclosure relates to an instruction execution method and apparatus, a computer device, a storage medium, and a computer program product. The method includes: receiving an instruction transmitted by a wave controller in each even-numbered clock cycle, wherein two instructions received in two consecutive even-numbered clock cycles correspond to an even-numbered wave and an odd-numbered wave respectively; acquiring a source operand from a first common register file when the instruction corresponds to the even-numbered wave, or acquiring a source operand from a second common register file when the instruction corresponds to the odd-numbered wave; and executing the instruction based on the source operand. With the method, the execution efficiency can be improved.

### CROSS-REFERENCE TO RELATED APPLICATION

The application claims priority to Chinese Patent Application No. 202411163866.4, filed with the China National Intellectual Property Administration on Aug. 22, 2024 and entitled “Instruction Execution Method and Apparatus, Computer Device, Storage Medium, and Computer Program Product”, which is incorporated herein by reference in its entirety.

### TECHNICAL FIELD

The present disclosure relates to the field of common graphics processor technology, particularly to an instruction execution method and apparatus, a computer device, a storage medium, and a computer program product.

### BACKGROUND

In a common graphics processor, a computing unit is a core module in the entire processor, and a wave controller is a key to properly schedule and control effective operation of the computing unit. On mainstream rendering platforms such as D3D, OpenGL, and Vulkan, various programmable shaders are most important and most time-consuming parts in the graphics rendering. These shaders include a Vertex Shader (VS), a Pixel Shader (PS), a Hull Shader (HS), and a Domain Shader (DS). In these shaders, in addition to texture sampling instructions and memory read/write instructions, computing instructions account for the largest proportion. Therefore, the execution efficiency of the computing instruction is particularly important in the common graphics processor.

In the common processor, the read-write conflict problem in a common register file often exists between two consecutive instructions for the same wave. In order to solve the problem, a compiler needs to insert a NOP instruction between the two instructions. Since a Wave Controller (WVC) transmits an instruction to each SET in each even-numbered clock cycle, and each SET reads and writes the same common register file (CRF), a delay between two consecutive instructions for the same wave is only two clock cycles, which may lead to the need for inserting more NOP instructions to solve the read-write conflict problem in the common register file, thereby resulting in a decrease in execution efficiency.

### SUMMARY

In view of this, as for the above technical problem, it is necessary to provide an instruction execution method and apparatus, a computer device, a computer-readable storage medium, and a computer program product capable of improving execution efficiency of instructions.

In the first aspect of the present disclosure, an instruction execution method is provided, which is applied to an algorithm logic unit, and may include: receiving an instruction transmitted by a wave controller in each even-numbered clock cycle, wherein two instructions received in two consecutive even-numbered clock cycles correspond to an even-numbered wave and an odd-numbered wave respectively; acquiring a source operand from a first common register file when the instruction corresponds to the even-numbered wave, or acquiring a source operand from a second common register file when the instruction corresponds to the odd-numbered wave; and executing the instruction based on the source operand.

In an embodiment, the method may further include: after executing the instruction based on the source operand, performing an instruction operation based on the source operand and obtaining a destination operand; storing the destination operand in the first common register file when the instruction corresponds to the even-numbered wave, or storing the destination operand in the second common register file when the instruction corresponds to the odd-numbered wave.

In an embodiment, the number of waves is equal to a power of two.

In the second aspect of the present disclosure, an instruction execution method is provided, which is applied to a wave controller, and may include: transmitting an instruction to an algorithm logic unit of each instruction execution module group in each even-numbered clock cycle, wherein two instructions transmitted to the same instruction execution module group in two consecutive even-numbered clock cycles correspond to an even-numbered wave and an odd-numbered wave respectively; storing a source operand in a first common register file of the instruction execution module group when the instruction corresponds to the even-numbered wave, or storing the source operand in a second common register file of the instruction execution module group when the instruction corresponds to the odd-numbered wave.

In an embodiment, the method may further include: before transmitting the instruction to the algorithm logic unit of each instruction execution module group in each even-numbered clock cycle, cyclically acquiring instructions from an instruction cache based on the number of instruction execution module groups, wherein one instruction is acquired in each clock cycle, and instructions acquired from the instruction cache in adjacent clock cycles correspond to different instruction execution module groups.

In the third aspect of the present disclosure, an instruction execution apparatus is provided, which may include: a wave controller, configured to transmit an instruction to an algorithm logic unit in each even-numbered clock cycle; a first common register file, configured to store source operands of instructions corresponding to even-numbered waves; a second common register file, configured to store source operands of instructions corresponding to odd-numbered waves; and the algorithm logic unit, configured to execute the above-mentioned instruction execution method to execute the instruction transmitted by the wave controller.

In an embodiment, the apparatus may further include: an instruction cache, configured to store instructions. The wave controller is further configured to cyclically acquire instructions from the instruction cache based on the number of instruction execution module groups corresponding to the algorithm logic unit, wherein one instruction is acquired in each clock cycle, and instructions acquired from the instruction cache in adjacent clock cycles correspond to different instruction execution module groups.

In an embodiment, the wave controller is further configured to transmit an instruction to an algorithm logic unit of each instruction execution module group in each even-numbered clock cycle; two instructions transmitted to the same instruction execution module group in two consecutive even-numbered clock cycles correspond to an even-numbered wave and an odd-numbered wave respectively.

In an embodiment, the number of waves is equal to a power of two.

In the fourth aspect of the present disclosure, a computer device is provided, including a processor and a memory storing a computer program. The processor, when executing the computer program, may implement the method in any of the above embodiments.

In the fifth aspect of the present disclosure, a computer-readable storage medium is provided, on which a computer program is stored. The computer program, when executed by a processor, may cause the processor to implement the method in any of the above embodiments.

In the sixth aspect of the present disclosure, a computer program product is provided, including a computer program. The computer program, when executed by a processor, may cause the processor to implement the method in any of the above embodiments.

In the above-mentioned instruction execution method and apparatus, computer device, computer-readable storage medium, and computer program product, the instruction transmitted by the wave controller is received in each even-numbered clock cycle, and two instructions received in two consecutive even-numbered clock cycles correspond to the even-numbered wave and the odd-numbered wave respectively, the source operand is acquired from the first common register file when the instruction corresponds to the even-numbered wave, the source operand is acquired from the second common register file when the instruction corresponds to the odd-numbered wave, so that the source operands are stored in different common register files respectively, and the two instructions received in two consecutive even-numbered clock cycles correspond to the even-numbered wave and the odd-numbered wave respectively. Accordingly, there exists an execution of an instruction corresponding to an odd-numbered wave between the executions of the instructions corresponding to two even-numbered waves, a clock cycle between the executions of the instructions corresponding to two even-numbered waves can be extended, thereby reducing the number of the inserted NOP instructions. Similarly, for the odd-numbered waves, the number of the inserted NOP instructions may also be reduced. Accordingly, the execution efficiency is improved.

### BRIEF DESCRIPTION OF THE DRAWINGS

In order to describe the technical solution in the embodiments of the present disclosure or the related technologies more clearly, the accompanying drawings required for describing the embodiments of the present disclosure or the related technologies are briefly introduced. Obviously, the accompanying drawings in the following description show merely some embodiments of the present disclosure, and those skilled in the art may still obtain other related drawings according to these accompanying drawings without any creative efforts.

FIG. 1 is an operation block diagram of a conventional wave controller.

FIG. 2 is a block diagram of an instruction execution apparatus according to an embodiment.

FIG. 3 is a clock diagram of an execution process of one instruction according to an embodiment.

FIG. 4 is a flow chart showing an instruction execution method according to an embodiment.

FIG. 5 is a flow chart showing an instruction execution method according to another embodiment.

FIG. 6 is a clock diagram of executions of instructions corresponding to waves in conventional technology.

FIG. 7 is a clock diagram of alternating executions of instructions corresponding to even-numbered and odd-numbered waves according to an embodiment.

FIG. 8 is a schematic diagram of a common register read-write conflict according to an embodiment.

FIG. 9 is a schematic diagram of a common register read-write conflict according to another embodiment.

FIG. 10 is a clock diagram of executions of instructions with dependencies in the conventional technology.

FIG. 11 is a schematic diagram of a common register read-write conflict according to another embodiment.

FIG. 12 is a clock diagram of executions of instructions with dependencies according to an embodiment.

FIG. 13 is an internal structure diagram of a computer device according to an embodiment.

### DETAILED DESCRIPTION OF THE EMBODIMENTS

In order to make the purpose, technical solution and advantages of the present disclosure more clearly understood, the present disclosure is further described in detail below in conjunction with the accompanying drawings and embodiments. It should be appreciated that the specific embodiments described herein are merely used for illustrating the present disclosure, rather than limiting the present disclosure.

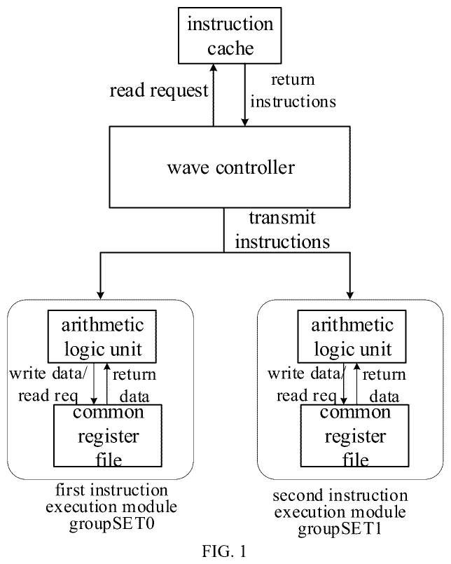

The operation block diagram of the conventional wave controller (WVC) is shown in FIG. 1. Each WVC corresponds to two algorithm logic units (ALUs), and each ALU corresponds to a common register file (CRF). In addition, an instruction cache (IC) is configured for the wave controller. The WVC may transmit an address of an instruction to be executed by the wave to the IC. The IC takes the instruction from a buffer or a memory according to the address of the instruction and transmits the instruction to the WVC.

The existing method for transmitting the wave instruction has the following two shortcomings.

Since only one CRF is configured for each ALU, when the ALU and CRF operate at the same frequency, the ALU can only read one source operand from the CRF in each clock cycle, resulting that the instruction cannot support multiple source operands.

In the common processor, a common register read-write conflict problem often exists between the two consecutive instructions for the same wave. In order to solve the problem, a compiler needs to insert a NOP instruction between the two instructions. Since WVC transmits one instruction to each SET in each even-numbered clock cycle, and each SET reads and writes the same CRF, the delay between two instructions for the same wave is only two clock cycles, which may result in more NOP instructions needing to be inserted in order to solve the register read-write conflict problem.

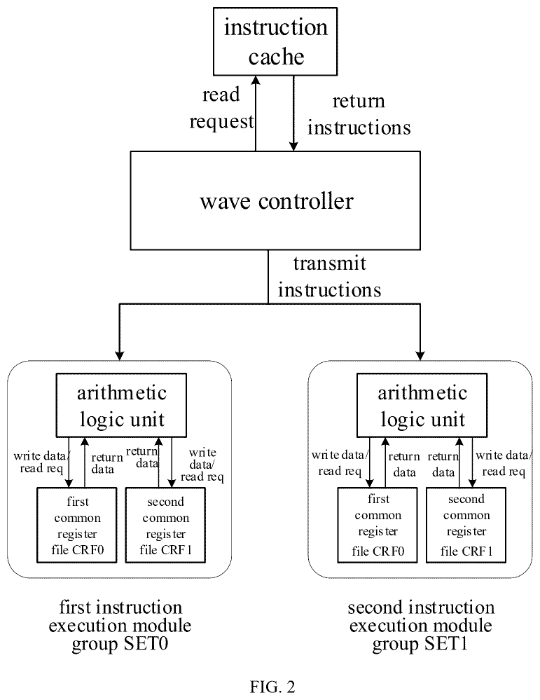

The instruction execution method provided in the embodiment of the present disclosure can be applied to an application environment shown in FIG. 2. The method mainly involves a wave controller, an instruction cache, a common register file, and an algorithm logic unit.

The instruction cache (IC) is configured to store a certain number of instructions. When the instruction cache receives an instruction fetch request from the wave controller, the instruction cache first queries from an internal cache. If the instruction requested by the wave controller is found, the instruction is returned immediately. Otherwise, the instruction requested by the wave controller is read from an external memory, stored in the internal cache, and transmitted to the wave controller.

The wave controller (WVC) is configured to schedule and execute instructions for a certain number of waves. The number of waves is generally equal to a power of 2. In the present disclosure, 32 is taken as an example. The wave controller is mainly configured to fetch instructions from the instruction cache and transmit the instructions to the algorithm logic unit.

The algorithm logic unit (ALU) is configured to receive an instruction transmitted by the wave controller, read a source operand from the common register file, execute the instruction, and write an execution result of the instruction to the common register file.

The common register file (CRF) is configured to store source operands and destination operands of instructions.

In the present disclosure, two common register files are provided for each algorithm logic unit, namely a first common register file CRF0 and a second common register file CRF1. The two common register files and the algorithm logic unit constitute an instruction execution module group SET. Each wave controller is configured to manage 32 waves, and each of the waves has a corresponding index number, ranging from 0 to 31. Instructions of waves with index numbers 0 to 15 are transmitted to the first instruction execution module group SETO for execution. Instructions of waves with index numbers 16 to 31 are transmitted to the second instruction execution module group SET1 for execution. Here, 32 waves are taken as an example to illustrate the present disclosure, and the present disclosure is not limited to 32. The number of waves is generally equal to a power of 2. Meanwhile, the number of instruction execution module groups SETs is not fixed, which may be 2, 4, or 8, etc. In the present disclosure, two instruction execution module groups are taken as an example.

For each instruction execution module group SET, when receiving an instruction of a wave with an even index number, the algorithm logic unit reads a source operand from the first common register file CRF0 and writes the execution result of the instruction into the first common register file CRF0. Similarly, when receiving an instruction of a wave with an odd index number, the algorithm logic unit reads a source operand from the second common register file CRF1 and writes the execution result of the instruction into the second common register file CRF1.

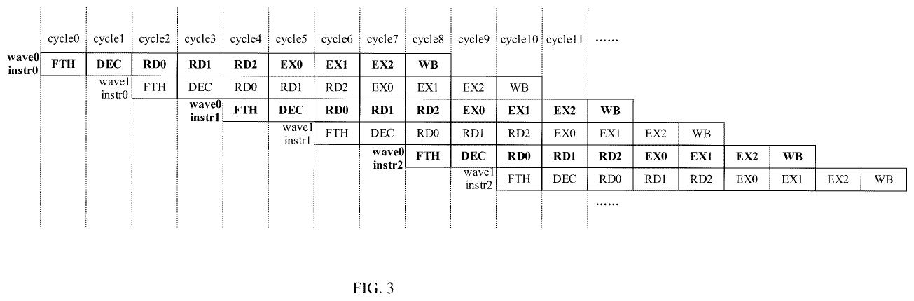

For ease of understanding, with reference to FIG. 3, it is a clock diagram of an execution process of one instruction in an embodiment. In the embodiment, the wave controller transmits an instruction to the algorithm logic unit, and the instruction is cyclically executed twice within the algorithm logic unit. However, source operands read during the two executions are different, and positions in the common register to which the execution results of the instruction are written are also different. In the embodiment, these two executions are referred to as low and high, and each common register file is correspondingly divided into a low bank and a high bank. Accordingly, as shown in FIG. 3, the wave controller only transmits an instruction at an even-numbered clock, and the execution of each instruction requires nine clock cycles, namely fetching instructions (FTH), decoding (DEC), reading first source operand (RD0), reading second source operand (RD1), reading third source operand (RD2), calculating first part (EX0), calculating second part (EX1), calculating third part (EX2), and writing destination operand (WB).

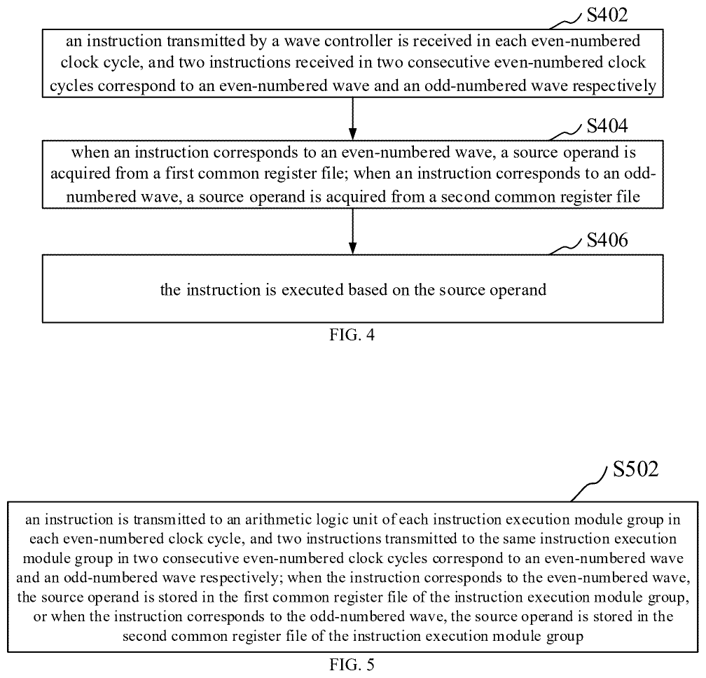

In an exemplary embodiment, as shown in FIG. 4, an instruction execution method is provided, which is applied to the algorithm logic unit in FIG. 2 as an example. The method may include the following steps S402 to S406.

S402: an instruction transmitted by a wave controller is received in each even-numbered clock cycle, and two instructions received in two consecutive even-numbered clock cycles correspond to an even-numbered wave and an odd-numbered wave respectively.

The clock cycle is an operating cycle of the wave controller. In each clock cycle, the wave is triggered to perform a corresponding operation. In the present disclosure, each clock cycle is numbered, starting with the 0-th clock cycle and increasing in a chronological order, so that the clock cycles can be divided into even-numbered clock cycles and odd-numbered clock cycles. Optionally, in the present disclosure, an instruction transmitted by the wave controller is received in each even-numbered clock cycle. It should be noted that the even-numbered clock cycles are adopted due to the fact that the clock cycles are numbered from 0. Optionally, if the clock cycles are numbered from 1, an instruction transmitted by the wave controller is received in each odd-numbered clock cycle. In other embodiments, it may be unrelated to the number of the starting clock cycle, and no specific limitation is made here. Those skilled in the art may appreciate that the even-numbered clock cycles here do not make any limitation to the present disclosure, and are merely for illustrating that an instruction emitted by the wave controller is received every two cycles.

The waves are scheduled and executed by the wave controller. In the present disclosure, 32 waves are taken as an example for illustration. In other embodiments, the number of waves may be other. Optionally, the number of waves is a power of 2.

Optionally, the instruction execution module group in the present disclosure may include an algorithm logic unit, a first common register file, and a second common register file. The number of instruction execution module groups is not specifically limited in the present disclosure, which may be 2, 4 or 8, etc. In the present disclosure, the number of instruction execution module groups is 2 taken as an example for illustration. In each clock cycle, the wave controller requests an instruction from the instruction cache. Two instructions requested in two consecutive clock cycles correspond to wave0-15 and wave16-31 respectively. Wave0-15 represents the 0-th wave to the 15-th wave, and wave16-31 represents the 16-th wave to the 31-st wave. Instructions corresponding to wave0-15 are transmitted to the first instruction execution module group SET0, and instructions corresponding to wave16-31 are transmitted to the second instruction execution module group SET1. In other embodiments, if the number of instruction execution module groups is equal to 4, instructions corresponding to wave0-7 are transmitted to the first instruction execution module group SETO, instructions corresponding to wave8-15 are transmitted to the second instruction execution module group SETI, instructions corresponding to wave16-23 are transmitted to the third instruction execution module group SET2, and instructions corresponding to wave24-31 are transmitted to the fourth instruction execution module group SET3.

For ease of understanding, as shown in FIG. 3, in each even-numbered clock cycle, the wave controller simultaneously transmits an instruction to the first instruction execution module group SETO and the second instruction execution module group SET1. Two instructions transmitted by the wave controller to the same instruction execution module group SET in two consecutive even-numbered clock cycles respectively correspond to an even-numbered wave and an odd-numbered wave. The even-numbered wave indicates that an index number of the wave is an even number, and an odd-numbered wave indicates that an index number of the wave is an odd number. As shown in FIG. 3, in the first even-numbered clock cycle (cycle0), instr0 corresponding to the even-numbered wave (wave0) is transmitted. In the second even-numbered clock cycle (cycle2), instr0 corresponding to the odd-numbered wave (wave1) is transmitted. In the third even-numbered clock cycle (cycle4), instr1 corresponding to the even-numbered wave (wave0) (or an instruction corresponding to an even-numbered wave, such as wave2, wave4, wave6) is transmitted. In the fourth even-numbered clock cycle (cycle6), instr1 corresponding to the odd-numbered wave (wave1) (or an instruction corresponding to an odd-numbered wave, such as wave3, wave5, wave7) is transmitted, and so on. The wave controller transmits instructions corresponding to even-numbered and odd-numbered waves alternately to the instruction execution module group SET.

S404: when an instruction corresponds to an even-numbered wave, a source operand is acquired from a first common register file; when an instruction corresponds to an odd-numbered wave, a source operand is acquired from a second common register file.

In the embodiment, the algorithm logic unit receives the instruction corresponding to the wave transmitted by the wave controller and transmits a read source operand request to the corresponding common register according to the index number of the wave. When the index number is an even number, a read request is transmitted to the first common register file CRF0; when the index number is an odd number, a read request is transmitted to the second common register file CRF1.

S406: the instruction is executed based on the source operand.

The algorithm logic unit receives the source operand returned by the common register module, and then performs the corresponding operation according to an instruction opcode.

In an optional embodiment, after the instruction is executed based on the source operand, the method may further include: an instruction operation is performed based on the source operand to obtain a destination operand; when the instruction corresponds to the even-numbered wave, the destination operand is stored in the first common register file, or when the instruction corresponds to the odd-numbered wave, the destination operand is stored in the second common register file.

The algorithm logic unit receives the source operand returned by a common register file (CRF), performs the corresponding operation according to the instruction opcode, and writes an operation result to the corresponding CRF. Similarly, for the read request of the CRF, the write request transmitted by the algorithm logic unit is also transmitted to the corresponding CRF according to the index number of the wave. The write request of the even-numbered wave is transmitted to the first common register file CRF0, and the write request of the odd-numbered wave is transmitted to the second common register file CRF1.

In the above instruction execution method, the instruction transmitted by the wave controller is received in each even-numbered clock cycle, and two instructions received in two consecutive even-numbered clock cycles correspond to the even-numbered wave and the odd-numbered wave respectively, the source operand is acquired from the first common register file when the instruction corresponds to the even-numbered wave, the source operand is acquired from the second common register file when the instruction corresponds to the odd-numbered wave, so that the source operands are stored in different common register files respectively, and the two instructions received in two consecutive even-numbered clock cycles correspond to the even-numbered wave and the odd-numbered wave respectively. Accordingly, there exists an execution of an instruction corresponding to an odd-numbered wave between the executions of the instructions corresponding to two even-numbered waves, a clock cycle between the executions of the instructions corresponding to two even-numbered waves can be extended, thereby reducing the number of the inserted NOP instructions. Similarly, for the odd-numbered waves, the number of the inserted NOP instructions may also be reduced. Accordingly, the execution efficiency is improved.

In an exemplary embodiment, as shown in FIG. 5, an instruction execution method is provided, which is applied to the wave controller in FIG. 2 as an example for illustration, and the method may include the following steps S502.

S502: an instruction is transmitted to an algorithm logic unit of each instruction execution module group in each even-numbered clock cycle, and two instructions transmitted to the same instruction execution module group in two consecutive even-numbered clock cycles correspond to an even-numbered wave and an odd-numbered wave respectively; when the instruction corresponds to the even-numbered wave, the source operand is stored in the first common register file of the instruction execution module group, or when the instruction corresponds to the odd-numbered wave, the source operand is stored in the second common register file of the instruction execution module group.

The clock cycle is the operating cycle of the wave controller. In each clock cycle, the wave is triggered to perform the corresponding operation. In the present disclosure, each clock cycle is numbered, starting with the 0-th clock cycle and increasing in a chronological order, so that the clock cycles can be divided into even-numbered clock cycles and odd-numbered clock cycles. Optionally, in the present disclosure, an instruction transmitted by the wave controller is received in each even-numbered clock cycle. It should be noted that the even-numbered clock cycles are adopted due to the fact that the clock cycles are numbered from 0. Optionally, if the clock cycles are numbered from 1, an instruction transmitted by the wave controller is received in each odd-numbered clock cycle. In other embodiments, it may be unrelated to the number of the starting clock cycle, and no specific limitation is made here. Those skilled in the art may appreciate that the even-numbered clock cycles here do not make any limitation to the present disclosure, and are merely for illustrating that an instruction emitted by the wave controller is received every two cycles.

The waves are scheduled and executed by the wave controller. In the present disclosure, 32 waves are taken as an example for illustration. In other embodiments, the number of waves may be other. Optionally, the number of waves is equal to a power of 2.

In addition, the instruction execution module group in the present disclosure may include an algorithm logic unit, a first common register file, and a second common register file. The number of instruction execution module groups is not specifically limited in the present disclosure, which may be 2, 4 or 8, etc. In the present disclosure, the number of instruction execution module groups is 2 taken as an example for illustration. In each clock cycle, the wave controller requests an instruction from the instruction cache. Two instructions requested in two consecutive clock cycles correspond to wave0-15 and wave16-31 respectively. Wave0-15 represents the 0-th wave to the 15-th wave, and wave16-31 represents the 16-th wave to the 31-st wave. Instructions corresponding to the wave0-15 are transmitted to the first instruction execution module group SET0, and instructions corresponding to wave16-31 are transmitted to the second instruction execution module group SET1. In other embodiments, if the number of instruction execution module groups is equal to 4, instructions corresponding to wave0-7 are transmitted to the first instruction execution module group SET0, instructions corresponding to wave8-15 are transmitted to the second instruction execution module group SET1, instructions corresponding to wave16-23 are transmitted to the third instruction execution module group SET2, and instructions corresponding to wave24-31 are transmitted to the fourth instruction execution module group SET3.

In order to facilitate understanding, as shown in FIG. 3, in each even-numbered clock cycle, the wave controller transmits an instruction to the first instruction execution module group SET0 and the second instruction execution module group SET1 simultaneously. The wave controller transmits two instructions to the same SET in two consecutive even-numbered clock cycles, one of the instructions corresponds to the even-numbered wave while the other corresponds to the odd-numbered wave. The even-numbered wave indicates that the index number of the wave is an even number, and an odd-numbered wave indicates that the index number of the wave is an odd number. As shown in FIG. 3, in the first even-numbered clock cycle (cycle0), instr0 corresponding to the even-numbered wave (wave0) is transmitted. In the second even-numbered clock cycle (cycle2), instr0 corresponding to the odd-numbered wave (wave1) is transmitted. In the third even-numbered clock cycle (cycle4), instr1 corresponding to the even-numbered wave (wave0) (or an instruction corresponding to an even-numbered wave, such as wave2, wave4, wave6) is transmitted. In the fourth even-numbered clock cycle (cycle6), instr1 corresponding to the odd-numbered wave (wave1) (or an instruction corresponding to an odd-numbered wave, such as wave3, wave5, wave7) is transmitted, and so on. The wave controller transmits instructions corresponding to even-numbered and odd-numbered waves alternately to the instruction execution module group SET.

In the embodiment, the algorithm logic unit receives the instruction corresponding to the wave transmitted by the wave controller, and transmits a read source operand request to the corresponding common register file according to the index number of the wave. When the index number is an even number, a read request is transmitted to the first common register file CRF0; when the index number is an odd number, a read request is transmitted to the second common register file CRF1.

In the above instruction execution method, the instruction transmitted by the wave controller is received in each even-numbered clock cycle, and two instructions received in two consecutive even-numbered clock cycles correspond to the even-numbered wave and the odd-numbered wave respectively, the source operand is acquired from the first common register file when the instruction corresponds to the even-numbered wave, or the source operand is acquired from the second common register file when the instruction corresponds to the odd-numbered wave, so that the source operands are stored in different common register files respectively, and the two instructions received in two consecutive even-numbered clock cycles correspond to the even-numbered wave and the odd-numbered wave respectively. Accordingly, there exists an execution of an instruction corresponding to an odd-numbered wave between the executions of the instructions corresponding to two even-numbered waves, a clock cycle between the executions of the instructions corresponding to two even-numbered waves can be extended, thereby reducing the number of the inserted NOP instructions. Similarly, for the odd-numbered waves, the number of the inserted NOP instructions may also be reduced. Accordingly, the execution efficiency is improved.

In an optional embodiment, before the instruction is transmitted to the algorithm logic unit of each instruction execution module group in each even-numbered clock cycle, the method may further include: instructions are cyclically acquired from the instruction cache based on the number of instruction execution module groups, one instruction is acquired in each clock cycle, and instructions acquired from the instruction cache in adjacent clock cycles correspond to different instruction execution module groups.

Optionally, the instruction execution module group in the present disclosure includes the algorithm logic unit, the first common register file, and the second common register file. In the present disclosure, the number of instruction execution module groups is not specifically limited, which may be 2, 4 or 8, etc. In the present disclosure, the number of instruction execution module groups is 2 taken as an example for illustration. In the embodiment, the wave controller requests one instruction from the instruction cache in each clock cycle, and two instructions requested in two consecutive clock cycles correspond to wave0˜15 and wave16˜31 respectively.

In other embodiments, if the number of instruction execution module groups is equal to 4, the wave controller requests one instruction from the instruction cache in each clock cycle, and four instructions requested in four consecutive clock cycles correspond to wave0-7, wave8-15, wave16-23 and wave24-31 respectively.

Accordingly, in the present disclosure, the number of instruction execution module groups can be determined first to control the circle, and then the instructions corresponding to instruction execution module groups are acquired from the instruction cache in sequence, with one instruction being acquired in each clock cycle.

In the above embodiment, the alternating executions of instructions corresponding to the even-numbered and odd-numbered waves can not only support instructions with multiple operands, but also improve the read-write conflict problem of the common register files.

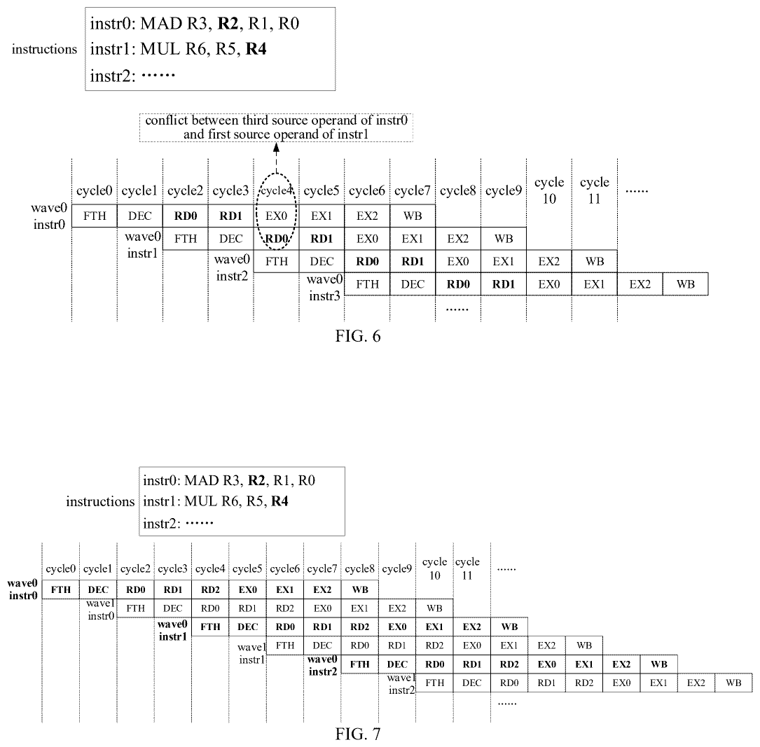

Specifically, as shown in FIG. 6, it is a clock diagram of executions of instructions corresponding to waves in the conventional technology. The wave controller transmits one instruction to each instruction execution module group SET every two clock cycles. Since there is no alternating transmission of instructions corresponding to the odd-numbered and even-numbered waves, and each instruction execution module group SET has only one common register file (CRF), all instructions transmitted to the same instruction execution module group SET access the same CRF.

Instructions in FIG. 6 are taken as an example, instr0 has three source operands. The algorithm logic unit reads the first source operand R0 and the second source operand R1 of instr0 in cycle2 and cycle3, and the algorithm logic unit reads the first source operand R4 and the second source operand R5 of instr1 in cycle4 and cycle5. The third source operand R2 of instr0 needs to be read in cycle4, which may conflict with the reading of the first source operand R4 of instr1, so that the existing method for transmitting instructions corresponding to waves cannot support the instruction with three or more source operands.

With reference to FIG. 7, it is a clock diagram of alternating executions of instructions corresponding to even-numbered and odd-numbered waves in an embodiment. In the embodiment, the wave controller transmits one instruction corresponding to an even-numbered wave to each instruction execution module group SET every four clock cycles. Similarly, the wave controller transmits one instruction corresponding to an odd-numbered wave to each instruction execution module group SET every four clock cycles. Two instructions transmitted in two consecutive even-numbered clock cycles (such as cycle0 and cycle2) correspond to the even-numbered wave and the odd-numbered wave respectively. Since the even-numbered wave and the odd-numbered wave access the first common register file CRF0 and the second common register file CRF1 respectively, there is no read-write conflict in the CRF between the even-numbered wave and the odd-numbered wave.

The method for transmitting an instruction corresponding to an even-numbered wave is taken as an example, the algorithm logic unit reads the first, second, and third source operands of wave0 instr0 from the first common register file CRF0 in cycle2, cycle3, and cycle4, and reads the first, second and third source operands of wave0 instr1 from the first common register file CRF0 in cycle6, cycle7 and cycle8. There is no conflict in reading operands between wave0 instr0 and wave0 instr1.

Similarly, the method for transmitting an instruction corresponding to an odd-numbered wave is taken as an example, the algorithm logic unit reads the first, second, and third source operands of wave1 instr0 from the second common register file CRF1 in cycle4, cycle5, and cycle6, and reads the first, second and third source operands of wave1 instr1 from the second common register file CRF1 in cycle8, cycle9, and cycle10. It can be seen that there is no conflict in reading operands between wave1 instr0 and wave1 instr1.

Therefore, the method of alternating executions of instructions corresponding to even-numbered and odd-numbered waves can support instructions with 3 or even 4 source operands.

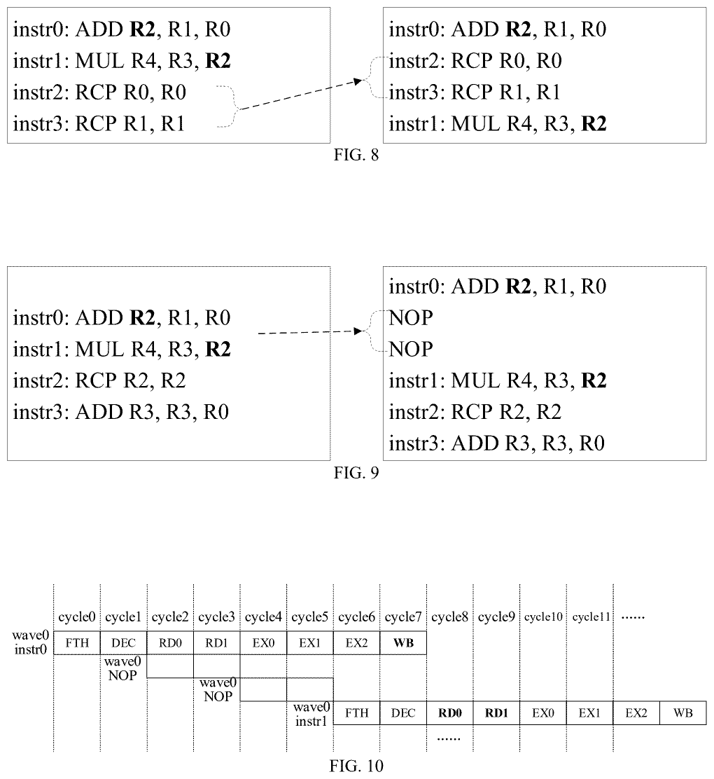

In common processors, there always exists a read-write conflict problem in the common register file (CRF). The instruction in FIG. 8 is taken as an example, assuming that the source operand R2 of the instruction instr1 MUL comes from the destination operand of the instruction instr0 ADD, then instr1 can read R2 after the result of instr0 is written into R2.

As shown in FIG. 8, since there is no dependency relationship between instr2/3 and instr0/1, a compiler can adjust the order of instructions and put two RCP instructions between the instructions ADD and MUL, in order to solve the read-write conflict problem of R2 by the instructions ADD and MUL.

However, in actual situations, as shown in FIG. 9, there is usually a dependency relationship between two consecutive instructions, and it is difficult for the compiler to insert instructions without a dependency relationship between two instructions with a dependency relationship by adjusting an order of instructions. Therefore, in general, the compiler solves the read-write conflict problem in CRF by inserting a NOP instruction.

As shown in FIG. 10, the algorithm logic unit writes the result of instr0 into R2 in cycle7. Accordingly, the algorithm logic unit needs to read R2 after the cycle7, otherwise, data stored in R2 refers to the old data before the update of ADD, resulting in a read-write conflict. In order to ensure the algorithm logic unit to read R2 after the cycle7, the wave controller needs to transmit instr1 to the algorithm logic unit in cycle 6, and cannot transmit the instr1 in cycle2 or cycle4. Accordingly, the compiler needs to insert two NOP instructions between instr0 and instr1, four cycles (cycle2 to cycle5) are consumed, and then the read-write conflict problem of R2 can be solved. The NOP instruction does not perform any operation, but consumes cycles and introduces delays. Therefore, the more NOP instructions are inserted, the worse the performance is.

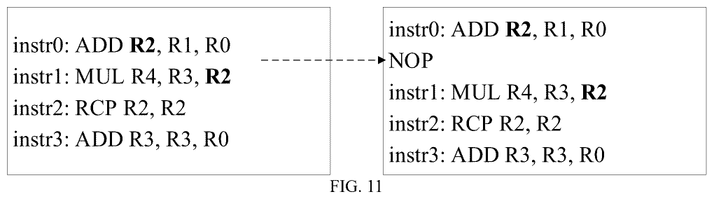

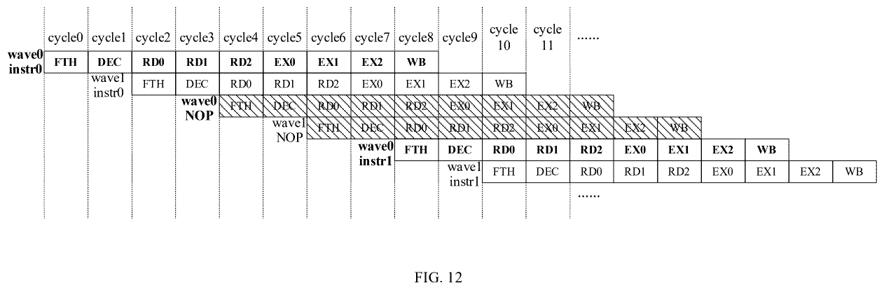

The same instruction is taken as an example (see FIG. 11), in the present disclosure, as shown in FIG. 12, a transmission clock of the even-numbered wave (wave0) is taken as an example, the wave controller can read the destination operand R2 of the wave0 instr instruction by transmitting the wave0 instr1 instruction in cycle8. Although there are six cycles between wave0 instr0 and wave0 instr1, the instruction corresponding to wave0 can only be transmitted in cycle4. When cycle2 and cycle6 are included in the transmission clock of the instructions of the odd-numbered waves, the transmissions of the instructions corresponding to the odd-numbered and even-numbered waves do not interfere with each other. Accordingly, as long as the wave controller does not transmit wave0 instr1 in cycle4, the read-write conflict problem of R2 corresponding to wave0 can be avoided.

Accordingly, only one NOP instruction needs to be inserted between wave0 instr0 and wave0 instr1. The wave controller transmits the wave0 NOP instruction in cycle4, which causes a delay of 2 cycles (cycle4 and cycle5), and ensures that wave0 instr1 is transmitted in cycle8, thereby solving the read-write conflict problem of R2 corresponding to wave0.

Similarly, from the transmission clock of the odd-numbered wave (wave1), it can be seen that wave1 instr0 writes the result into R2 in cycle10. The wave controller can read the R2 result of wave1 instr0 when transmitting wave1 instr1 in cycle10. Similarly, only one NOP instruction needs to be inserted between wave1 instr0 and wave 1 instr1 , which can ensure that wave1 instr1 is transmitted in cycle10. Accordingly, the read-write conflict problem of R2 corresponding to wave1 can be avoided.

Compared to the conventional instruction transmission method, the method of alternating executions of instructions corresponding to even-numbered and odd-numbered waves can reduce the number of NOPs from 2 to 1, thereby improving the execution performance of the algorithm logic unit.

In the above embodiment, the wave controller, the instruction cache, the common register file, and the algorithm logic unit can support instructions with three or even more operands when operating at the same frequency. In the common processors, a certain number of NOP instructions are introduced to solve the read-write conflict problem in the common register file. However, in the present disclosure, the number of NOP instructions is reduced, thereby improving the execution efficiency of instructions.

It should be appreciated that, although the steps in the flow charts involved in the above embodiments are displayed in sequence as indicated by the arrows, these steps are not definitely executed in the order indicated by the arrows. Unless otherwise specified herein, there is no strict order limitation for the execution of these steps, and these steps may be executed in other orders. Moreover, at least a part of the steps in the flow charts involved in the above embodiments may include multiple steps or multiple stages. These steps or stages are not definitely executed at the same moment but can be executed at different moments. These steps or stages are not definitely executed sequentially, but may be executed in turns or alternately with other steps or at least part of the steps or stages in other steps.

Based on the same inventive concept, in an embodiment of the present disclosure, an instruction execution apparatus for implementing the above-mentioned instruction execution method is provided. The implementation solution provided by the apparatus to solve the problem is similar to the implementation solution in the above method, as for the specific limitations in one or more embodiments of the instruction execution apparatus provided below, reference can be made to the limitations on the instruction execution method above, which will not be repeated here.

In an exemplary embodiment, with reference to FIG. 2, an instruction execution apparatus is provided, including:
a wave controller, configured to transmit an instruction to an algorithm logic unit in each even-numbered clock cycle;
a first common register file, configured to store source operands of instructions corresponding to even-numbered waves;
a second common register file, configured to store source operands of instructions corresponding to odd-numbered waves;
the algorithm logic unit, configured to execute the instruction execution method described in any one of the above embodiments to execute the instruction transmitted by the wave controller.

In an optional embodiment, the apparatus further includes:
an instruction cache, configured to store instructions;
the wave controller is further configured to cyclically acquire instructions from the instruction cache based on the number of instruction execution module groups corresponding to the algorithm logic unit; one instruction is acquired in each clock cycle, and instructions acquired from the instruction cache in adjacent clock cycles correspond to different instruction execution module groups.

Components in the above instruction execution apparatus can be implemented in whole or in part by software, hardware or a combination thereof. The above components may be embedded in or independent of a processor in a computer device in the form of hardware, or may be stored in a memory in a computer device in the form of software, so that the processor can call and execute operations corresponding to the above components.

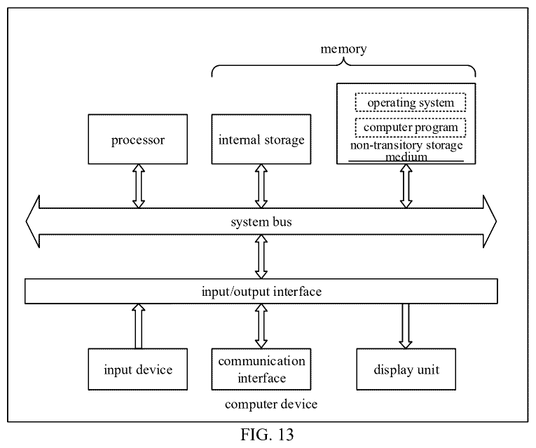

In an exemplary embodiment, a computer device is provided. The computer device may be a terminal, and an internal structure diagram thereof may be as shown in FIG. 13. The computer device includes a processor, a memory, an input/output interface, a communication interface, a display unit, and an input device. The processor, the memory, and the input/output interface are connected to each other via a system bus. The communication interface, the display unit, and the input device are connected to the system bus via the input/output interface. The processor of the computer device is configured to provide computing and control capabilities. The memory of the computer device includes a non-transitory storage medium and an internal storage. The non-transitory storage medium stores an operating system and a computer program. The internal storage provides an environment for operations of the operating system and computer program in the non-transitory storage medium. The input/output interface of the computer device is configured to exchange information between the processor and an external device. The communication interface of the computer device is configured to communicate with an external terminal in a wired or wireless manner. The wireless manner can be achieved through WIFI, mobile cellular network, near field communication (NFC) or other technologies. When the computer program is executed by the processor, an instruction execution method is implemented. A display unit of the computer device is configured to form a visually visible picture, and may be a display screen, a projection device or a virtual reality imaging device. The display screen can be a liquid crystal display screen or an electronic ink display screen, and the input device of the computer device can be a touch layer covering the display screen, or a button, trackball or touchpad provided on a housing of the computer device, or an external keyboard, touchpad or mouse, etc.

Those skilled in the art should understand that the structure shown in FIG. 13 is merely a block diagram of a partial structure related to the solution of the present disclosure, and does not constitute a limitation on the computer device to which the solution of the present disclosure is applied. The specific computer device may include more or fewer components than shown in the figure, or combine certain components, or have a different arrangement of components.

In an embodiment, a computer device is further provided, including a processor and a memory storing a computer program. The processor, when executing the computer program, may implement the steps in any of the above method embodiments.

In an embodiment, a computer-readable storage medium is provided, on which a computer program is stored. The computer program, when executed by a processor, may cause the processor to implement the steps in any of the above method embodiments.

In an embodiment, a computer program product is provided, including a computer program. The computer program, when executed by a processor, may cause the processor to implement the steps in any of the above method embodiments.

A person of ordinary skill in the art can understand that all or part of the processes in the above-mentioned embodiments of the method can be implemented by instructing related hardware through a computer program. The computer program may be stored in a non-transitory computer-readable storage medium. When the computer program is executed, the processes of the above-mentioned embodiments of the method are included. Any reference to a memory, a database, or other medium used in the embodiments provided in the present disclosure may include at least one of a non-transitory memory and a transitory memory. The non-transitory memory may include a read-only memory (ROM), a magnetic tape, floppy disk, a flash memory, an optical storage, a high-density embedded non-transitory memory, a resistive random access memory (ReRAM), a magnetoresistive random access memory (MRAM), a ferroelectric random access memory (FRAM), a phase change memory (PCM), a graphene memory, etc. The transitory memory may include a random access memory (RAM) or an external cache memory, etc. By way of illustration and not limitation, the RAM may be in various forms, such as a static random access memory (SRAM) or a dynamic random access memory (DRAM). The database involved in each embodiment of the present disclosure may include at least one of a relational database and a non-relational database. The non-relational database may include, but is not limited to, a distributed database based on blockchain. The processor involved in each embodiment of the present disclosure may be a common-purpose processor, a central processing unit, a graphics processor, a digital signal processor, a programmable logic unit, a data processing logic unit based on quantum computing, artificial intelligence (AI) processor, etc., but is not limited thereto.

The technical features in the above embodiments may be combined arbitrarily. In order to make the description concise, all possible combinations of the technical features in the above embodiments are not described. However, as long as there is no contradiction in the combinations of these technical features, these combinations should be considered to be within the scope of the present disclosure.

The above-described embodiments only express several implementation modes of the present disclosure, and the descriptions are relatively specific and detailed, but should not be constructed as limiting the scope of the present disclosure. It should be noted that, those of ordinary skill in the art can make several transformations and improvements without departing from the concept of the present disclosure, and these all fall within the protection scope of the present disclosure. Therefore, the protection scope of the present disclosure should be subject to the appended claims.

What is claimed is:

1. An instruction execution method, comprising:
receiving an instruction transmitted by a wave controller in each even-numbered clock cycle, wherein two instructions received in two consecutive even-numbered clock cycles correspond to an even-numbered wave and an odd-numbered wave respectively;
acquiring a source operand from a first common register file when the instruction corresponds to the even-numbered wave, or acquiring a source operand from a second common register file when the instruction corresponds to the odd-numbered wave; and
executing the instruction based on the source operand.

2. The method according to claim 1, further comprising:
after executing the instruction based on the source operand,
performing an instruction operation based on the source operand and obtaining a destination operand;
storing the destination operand in the first common register file when the instruction corresponds to the even-numbered wave, or storing the destination operand in the second common register file when the instruction corresponds to the odd-numbered wave.

3. The method according to claim 1, wherein the number of waves is equal to a power of two.

4. An instruction execution method, comprising:
transmitting an instruction to an algorithm logic unit of each instruction execution module group in each even-numbered clock cycle, wherein two instructions transmitted to the same instruction execution module group in two consecutive even-numbered clock cycles correspond to an even-numbered wave and an odd-numbered wave respectively;
storing a source operand in a first common register file of the instruction execution module group when the instruction corresponds to the even-numbered wave, or storing the source operand in a second common register file of the instruction execution module group when the instruction corresponds to the odd-numbered wave.

5. The method according to claim 4, further comprising:
before transmitting the instruction to the algorithm logic unit of each instruction execution module group in each even-numbered clock cycle,
cyclically acquiring instructions from an instruction cache based on the number of instruction execution module groups, wherein one instruction is acquired in each clock cycle, and instructions acquired from the instruction cache in adjacent clock cycles correspond to different instruction execution module groups.

6. An instruction execution apparatus, comprising:
a wave controller, configured to transmit an instruction to an algorithm logic unit in each even-numbered clock cycle;
a first common register file, configured to store source operands of instructions corresponding to even-numbered waves;
a second common register file, configured to store source operands of instructions corresponding to odd-numbered waves; and
the algorithm logic unit, configured to execute the instruction execution method of claim 1 to execute the instruction transmitted by the wave controller.

7. The apparatus according to claim 6, further comprising:
an instruction cache, configured to store instructions;
wherein the wave controller is further configured to cyclically acquire instructions from the instruction cache based on the number of instruction execution module groups corresponding to the algorithm logic unit, wherein one instruction is acquired in each clock cycle, and instructions acquired from the instruction cache in adjacent clock cycles correspond to different instruction execution module groups.

8. The apparatus according to claim 6, wherein the wave controller is further configured to transmit an instruction to an algorithm logic unit of each instruction execution module group in each even-numbered clock cycle, wherein two instructions transmitted to the same instruction execution module group in two consecutive even-numbered clock cycles correspond to an even-numbered wave and an odd-numbered wave respectively.

9. The apparatus according to claim 6, wherein the number of waves is equal to a power of two.

10. A computer device, comprising a processor and a memory storing a computer program, wherein the processor, when executing the computer program, implements the method of claim 1.

11. A computer device, comprising a processor and a memory storing a computer program, wherein the processor, when executing the computer program, implements the method of claim 4.

12. A computer-readable storage medium, on which a computer program is stored, wherein the computer program, when executed by a processor, causes the processor to implement the method of claim 1.

13. A computer-readable storage medium, on which a computer program is stored, wherein the computer program, when executed by a processor, causes the processor to implement the method of claim 4.

14. A computer program product, comprising a computer program, wherein the computer program, when executed by a processor, causes the processor to implement the method of claim 1.

15. A computer program product, comprising a computer program, wherein the computer program, when executed by a processor, causes the processor to implement the method of claim 4.
